(19) United States
(12) Patent Application Publication
(10) Pub. No.: US 2024/0104639 A1
(43) Pub. Date: Mar. 28, 2024

(54) TECHNIQUES FOR IMPLEMENTING DYNAMIC INTERACTIVE ON-DEMAND USER INTERFACE ORDERING

(71) Applicant: Apple Inc., Cupertino, CA (US)

(72) Inventors: Alan ZAVARI, Dublin, CA (US); Lamia YOUSEFF, Cupertino, CA (US)

(21) Appl. No.: 18/157,056

(22) Filed: Jan. 19, 2023

Related U.S. Application Data
(60) Provisional application No. 63/376,994, filed on Sep. 23, 2022.

(51) Int. Cl. G06Q 30/0601; G06F 3/0482; G06T 11/00

(52) U.S. Cl. CPC G06Q 30/0643; G06F 3/0482; G06Q 30/0635; G06T 11/00; G06T 2200/24

(57) ABSTRACT

This Application sets forth techniques for implementing dynamic interactive on-demand user interface ordering. In particular, in one embodiment a method for providing an interactive user interface is disclosed. The method may include receiving, from an input peripheral, a request to present a content item on the interactive user interface, presenting, on the interactive user interface, the content item, receiving, from the input peripheral, an input to select an object associated with the content item that is presented on the interactive user interface, responsive to receiving the input, presenting information pertaining to the object and at least one graphical user element configured to enable a purchase event to be performed.

### CROSS-REFERENCE TO RELATED APPLICATIONS

The present application claims the benefit of U.S. Provisional Application No. 63/376,994, entitled “TECHNIQUES FOR IMPLEMENTING DYNAMIC INTERACTIVE ON-DEMAND USER INTERFACE ORDERING,” filed Sep. 23, 2022, the content of which is incorporated by reference herein in its entirety for all purposes.

### FIELD

The described embodiments set forth techniques for implementing dynamic interactive on-demand user interface ordering.

### BACKGROUND

Content items (e.g., songs, movies, videos, podcasts, transcriptions, etc.) are conventionally played via a computing device, such as a smartphone, laptop, desktop, television, or the like. The industry associated with content item playback and/or streaming is massive. Oftentimes, people consume the content items (e.g., watch television shows, movies, and/or streaming content) and see one or more objects included in the content items that interest them. The objects may pertain to goods (e.g., products) and/or services. However, there currently is not a convenient way to obtain the object that a person desires in a content item displayed via a user interface.

### SUMMARY

This Application sets forth techniques for implementing dynamic interactive on-demand user interface ordering.

One embodiment sets forth a method for providing an interactive user interface. According to some embodiments, the method includes the steps of (1) receiving, from an input peripheral, a request to present a content item on the interactive user interface, (2) presenting, on the interactive user interface, the content item, (3) receiving, from the input peripheral, an input to select an object associated with the content item that is presented on the interactive user interface, and (4) responsive to receiving the input, presenting information pertaining to the object and at least one graphical user element configured to enable a purchase event to be performed.

Another embodiment sets forth a tangible, non-transitory computer-readable medium storing instructions that, when executed, cause a processing device to: (1) receive, from an input peripheral, a request to present a content item on the interactive user interface, (2) present, on the interactive user interface, the content item, (3) receive, from the input peripheral, an input to select an object associated with the content item that is presented on the interactive user interface, and (4) responsive to receiving the input, present information pertaining to the object and at least one graphical user element configured to enable a purchase event to be performed.

Yet another embodiment includes a system including a memory device storing instructions and a processing device communicatively coupled to the memory device. The processing device executes the instructions to cause the system to: (1) receive, from an input peripheral, a request to present a content item on the interactive user interface, (2) present, on the interactive user interface, the content item, (3) receive, from the input peripheral, an input to select an object associated with the content item that is presented on the interactive user interface, and (4) responsive to receiving the input, present information pertaining to the object and at least one graphical user element configured to enable a purchase event to be performed.

Other embodiments include hardware computing devices that include processors that can be configured to cause the hardware computing devices to implement the methods and techniques described in this disclosure.

Other aspects and advantages of the invention will become apparent from the following detailed description taken in conjunction with the accompanying drawings which illustrate, by way of example, the principles of the described embodiments.

This Summary is provided merely for purposes of summarizing some example embodiments so as to provide a basic understanding of some aspects of the subject matter described herein. Accordingly, it will be appreciated that the above-described features are merely examples and should not be construed to narrow the scope or spirit of the subject matter described herein in any way. Other features, aspects, and advantages of the subject matter described herein will become apparent from the following Detailed Description, Figures, and Claims.

### BRIEF DESCRIPTION OF THE DRAWINGS

The disclosure will be readily understood by the following detailed description in conjunction with the accompanying drawings, wherein like reference numerals designate like structural elements.

FIG. 1 illustrates a system architecture, according to some embodiments disclosed herein.

FIG. 2 illustrate a conceptual diagram of example interactions between a wireless device and an interactive user interface, according to some embodiments disclosed herein.

FIG. 3 illustrates an example interactive user interface that provides information related to a selected object and options for performing a purchase event, according to some embodiments disclosed herein.

FIG. 4 illustrates an example user interface of an application that enables ordering selected objects, according to some embodiments disclosed herein.

FIG. 5 illustrates a method for providing an interactive user interface that enables dynamic on-demand ordering, according to some embodiments disclosed herein.

FIG. 6 illustrates a method for performing a purchase event in response to receiving a selection of a graphical user element, according to some embodiments disclosed herein.

FIG. 7 illustrates a method for enabling a purchase event of an object to be performed while playback of a content item is paused, according to some embodiments disclosed herein.

FIG. 8 illustrates a detailed view of a representative computing device that can be used to implement various techniques described herein, according to some embodiments.

### DETAILED DESCRIPTION

Representative applications of methods and apparatus according to the present application are described in this section. These examples are being provided solely to add context and aid in the understanding of the described embodiments. It will thus be apparent to one skilled in the art that the described embodiments may be practiced without some or all of these specific details. In other instances, well known process steps have not been described in detail in order to avoid unnecessarily obscuring the described embodiments. Other applications are possible, such that the following examples should not be taken as limiting.

In the following detailed description, references are made to the accompanying drawings, which form a part of the description, and in which are shown, by way of illustration, specific embodiments in accordance with the described embodiments. Although these embodiments are described in sufficient detail to enable one skilled in the art to practice the described embodiments, it is understood that these examples are not limiting; such that other embodiments may be used, and changes may be made without departing from the spirit and scope of the described embodiments.

The described embodiments set forth techniques for providing a dynamic on-demand interactive user interface for ordering an object displayed via a computing device. Any content item may be played and/or streamed via a computing device, such as a television, a monitor, a smartphone, a stand-alone computing device, or the like. There may be multiple objects displayed or included in the content item. For example, a woman may be wearing certain clothes, carrying certain accessories (e.g., a handbag, a fanny pack, etc.), walking a certain type of dog, and so on. A consumer of the content item may view the content item and desire to obtain one or more of the objects presented in the content item. Conventionally, the consumer may perform an internet search for the object they saw in the content item and want to obtain. However, such a technique is inefficient because the consumer lacks the exact detailed information pertaining to the object. Accordingly, there exists a need for more efficient and accurate acquisition of objects presented in content items.

The present disclosure provides a technical solution to enable a consumer of a content item to obtain one or more objects presented in the content item in an on-demand manner based on dynamically updated information pertaining to the objects. That is, the information pertaining to objects may be updated in real-time or near real-time (e.g., real-time may refer to less than two (2) seconds and near real-time may refer to a period of time between two (2) seconds and ten (10) seconds) via a third-party service and/or application programming interface (API) managed by an entity associated with the object. For example, a company that makes a particular brand of handbags may update pricing information related to its handbags, and that information may be propagated via communicatively coupled servers, APIs, services, etc., to be dynamically displayed on an interactive user interface provided by some embodiments disclosed herein. The interactive user interface may enable a user to view identified objects included in scenes of a content item and allow the user to select a desired object. In some embodiments, the interactive user interface may pause playback of the content item and augment a visual representation of one or more objects presented in the content item. The user may select, using an input peripheral (e.g., a microphone, a keyboard, a mouse, a touchscreen, a remote controller, a smartphone, etc.), a desired object to view information pertaining to the object. The user may then use the input peripheral to perform a purchasing event, such as adding the desired object to a virtual shopping cart and/or immediately purchasing the object.

In some embodiments, the user may purchase the object using stored payment information (e.g., credit card details, payment service details via a single input, and the like). The single input may be a single click of a graphical user element, a spoken word into a microphone, and so on. In such a way, the disclosed embodiments provide a technical solution by reducing computing resources through reduced interactions with a computing device. Further, the disclosed embodiments provide a technical solution by providing an enhanced graphical user interface that is interactive, on-demand, dynamic, and allows users to order objects presented in the user interface in real-time or near real-time.

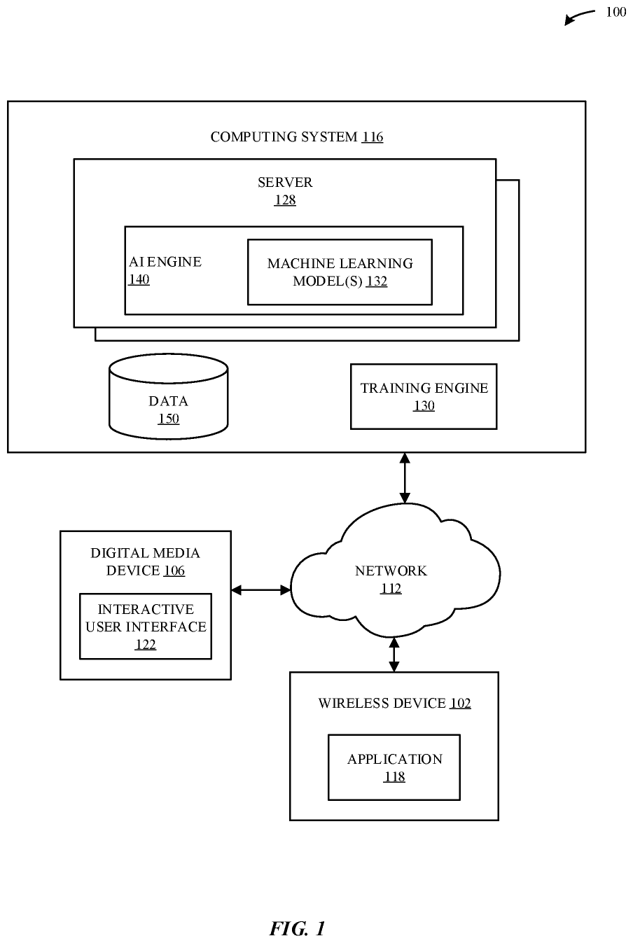

These and other embodiments are discussed below with reference to FIGS. 1-8; however, those skilled in the art will readily appreciate that the detailed description given herein with respect to these figures is for explanatory purposes only and should not be construed as limiting.

FIG. 1 illustrates a system architecture 100 that may include one or more computing devices 102 of one or more users communicatively coupled to a computing system 116 and/or a digital media device 106.

According to some embodiments, a digital media device 106 can be configured or controlled by a mobile device, e.g., a smart mobile phone. The digital media device 106 may be an electronic device programmed to download and/or stream multimedia content including pictures, audio, or video. For example, digital media device 106 can be a Digital Mobile Radio (DMR), a digital audio or video player, a mobile or stationary computing device, a digital camera, an Internet-enabled television, a gaming console, and the like. Digital media device 106 may include or be coupled to a display device (e.g., a television) that presents an interactive user interface 122. The interactive user interface 122 may present dynamic information pertaining to identified objects in a content item playing via the display device. A user may use an input peripheral to interact with the interactive user interface 122 to perform a purchase event in real-time or near real-time to obtain a desired object. The content item may include an advertisement with the one or more objects that may be ordered.

In some embodiments, the computing system 116 may also be configured or controlled by a mobile device, e.g., a smart mobile phone. The computing system 116 may be an electronic device programmed to download or play multimedia content including pictures, audio, or video. For example, computing system 116 can be a DMR, a digital audio or video player, a mobile or stationary computing device, a digital camera, an Internet-enabled television, a gaming console, and the like. The computing system 116 may include or be coupled to a display device that presents an interactive user interface 122

Each of the wireless device 102, digital media device 106, and components included in the computing system 116 may include one or more processing devices, memory devices, and/or network interface cards. The network interface cards may enable communication via a wireless protocol for transmitting data over short distances, such as Bluetooth, ZigBee, NFC, and the like. Additionally, the network interface cards may enable communicating data over long distances, and in one example, the computing devices 12 and the computing system 116 may communicate with a network 112. Network 112 may be a public network (e.g., connected to the Internet via wired (Ethernet) or wireless (Wi-Fi)), a private network (e.g., a local area network (LAN) or wide area network (WAN)), or a combination thereof. Network 112 may also comprise a node or nodes on the Internet of Things (IoT).

The wireless device 102 may be any suitable computing device, such as a laptop, tablet, smartphone, wearable, computer, and the like. The wireless device 102 may include a memory device storing computer instructions implementing an application 118 that is executed by a processing device. When executed, the application 118 may present a user interface (e.g., on a display to which the wireless device 102 is communicably coupled) and an object that is selected by a user via the interactive user interface 122, may present a virtual shopping cart including the object that is selected, may present one or more graphical user elements that enable the user to order the selected one or more objects, and the like. Accordingly, the application 118 may present various user interface screens to a user.

In some embodiments, the computing system 116 may include one or more servers 128 that form a distributed computing architecture. In some embodiments, the computing system 116 may be a set top box, such as an Apple TV®. The servers 128 may be a rackmount server, a router computer, a personal computer, a portable digital assistant, a mobile phone, a laptop computer, a tablet computer, a camera, a video camera, a netbook, a desktop computer, a media center, any other device capable of functioning as a server, or any combination of the above. Each of the servers 128 may include one or more processing devices, memory devices, data storage, and/or network interface cards. The servers 128 may be in communication with one another via any suitable communication protocol. The servers 128 may execute an artificial intelligence (AI) engine 140 that uses one or more machine learning models 132 to perform at least one of the embodiments disclosed herein. The computing system 116 may also include a database 150 that stores data, knowledge, and data structures used to perform various embodiments. For example, the database 150 may store content items, information pertaining to objects included in the content items, and the like. In some embodiments, the database 150 may be hosted on one or more of the servers 128.

In some embodiments the computing system 116 may include a training engine 130 capable of generating the one or more machine learning models 132. The machine learning models 132 may be trained to perform image analyses to identify one or more objects included in a content item, and to mark the one or more objects via augmenting, highlighting, outlining, coloring, modifying, and so on. The one or more machine learning models 132 may be trained with training data that includes labeled inputs mapped to labeled outputs. For instance, a content item may be comprised of numerous image frames and the image frames may include labels identifying certain objects included in each image frame. In one example, a handbag may be labeled with a marker that indicates the handbag is a handbag made by a certain brand, is sold for a certain price, etc. The labeled output may include the information (e.g., brand, price, etc.) pertaining to the labeled input. The one or more machine learning models 132 may be generated by the training engine 130 and may be implemented in computer instructions executable by one or more processing devices of the training engine 130 and/or the servers 128. To generate the one or more machine learning models 132, the training engine 130 may train the one or more machine learning models 132.

The training engine 130 may be a rackmount server, a router computer, a personal computer, a portable digital assistant, a smartphone, a laptop computer, a tablet computer, a netbook, a desktop computer, an Internet of Things (IoT) device, any other desired computing device, or any combination of the above. The training engine 130 may be cloud-based, be a real-time software platform, include privacy software or protocols, and/or include security software or protocols. To generate the one or more machine learning models 132, the training engine 130 may train the one or more machine learning models 132.

The one or more machine learning models 132 may refer to model artifacts created by the training engine 130 using training data that includes training inputs and corresponding target outputs. The training engine 130 may find patterns in the training data wherein such patterns map the training input to the target output and generate the machine learning models 132 that capture these patterns. For example, the machine learning model may receive a content item, parse image frames of the content item, identify objects in the image frames of the content item, mark the objects with certain labels, obtain information pertaining to the marked objects via a third-party service and/or application programming interface, and/or output the marked, identified objects with their associated information. Although depicted separately from the server 128, in some embodiments, the training engine 130 may reside on server 128. Further, in some embodiments, the database 150, and/or the training engine 130 may reside on the computing devices 102 and/or the digital media device 106.

As described in more detail below, the one or more machine learning models 132 may comprise, e.g., a single level of linear or non-linear operations (e.g., a support vector machine (SVM)) or the machine learning models 132 may be a deep network, i.e., a machine learning model comprising multiple levels of non-linear operations. Examples of deep networks are neural networks, including generative adversarial networks, convolutional neural networks, recurrent neural networks with one or more hidden layers, and fully connected neural networks (e.g., each neuron may transmit its output signal to the input of the remaining neurons, as well as to itself). For example, the machine learning model may include numerous layers and/or hidden layers that perform calculations (e.g., dot products) using various neurons.

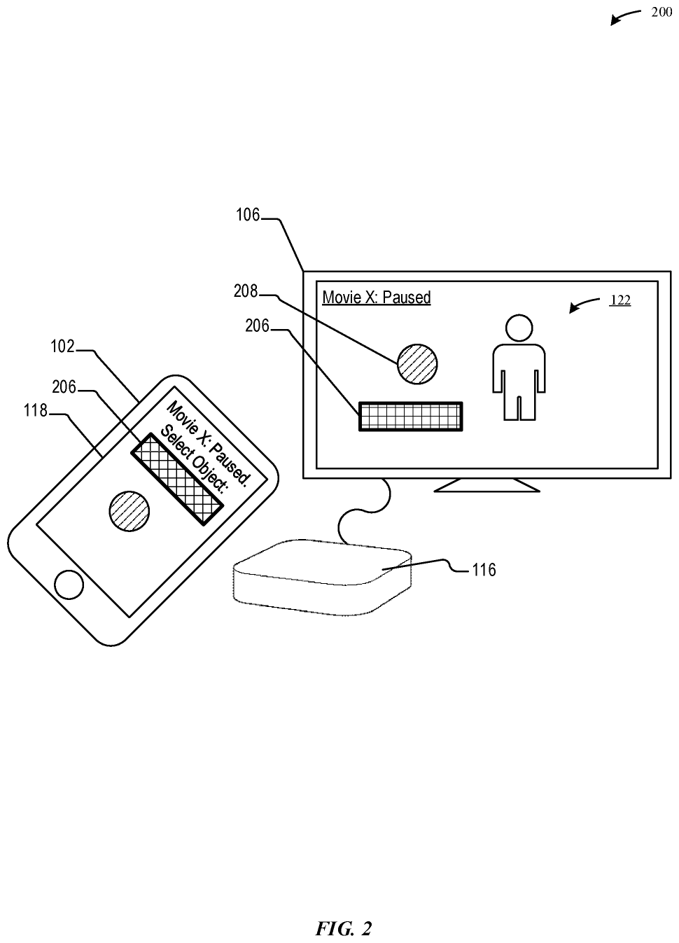

FIG. 2 illustrate a conceptual diagram 200 of example interactions between a wireless device 102 and an interactive user interface 122, according to some embodiments disclosed herein. As depicted, the digital media device 106 is presenting the interactive user interface 122. The digital media device 106, in this example, is a television and is communicatively connected to a computing system 116 (e.g., and Apple TV®). The computing system 116 may be communicatively coupled, via the network 112, to one or more servers 128 that provide one or more content items on-demand for a user that selects the one or more content items. For example, the computing system 116 may provide streaming of content items in real-time or near real-time. Further, the wireless device 102, in this example, may be a smartphone that executes an application 118 to perform one or more selections of objects and purchasing events of the selected objects.

In the depicted example, the user has used the wireless device 102 to pause the content item (e.g., “Movie X”). While the content item is paused, there are two objects 206 and 208 that are identified in the interactive user interface 122. The two objects 206 and 208 may be augmented, highlighted, outlined, colored, or the like to be identified. In some embodiments, the one or more machine learning models 132 may be trained to identify the one or more objects included in each image frame of a content item.

Further in the depicted example, the user has used the wireless device 102 to select object 206 (as represented with the shading in the interactive user interface 122). The user interface of the application 118 presented on the wireless device 102 shows the objects that have been identified in the content item, and further shows that the user has selected the object 206 (as represented with the shading in the application 118).

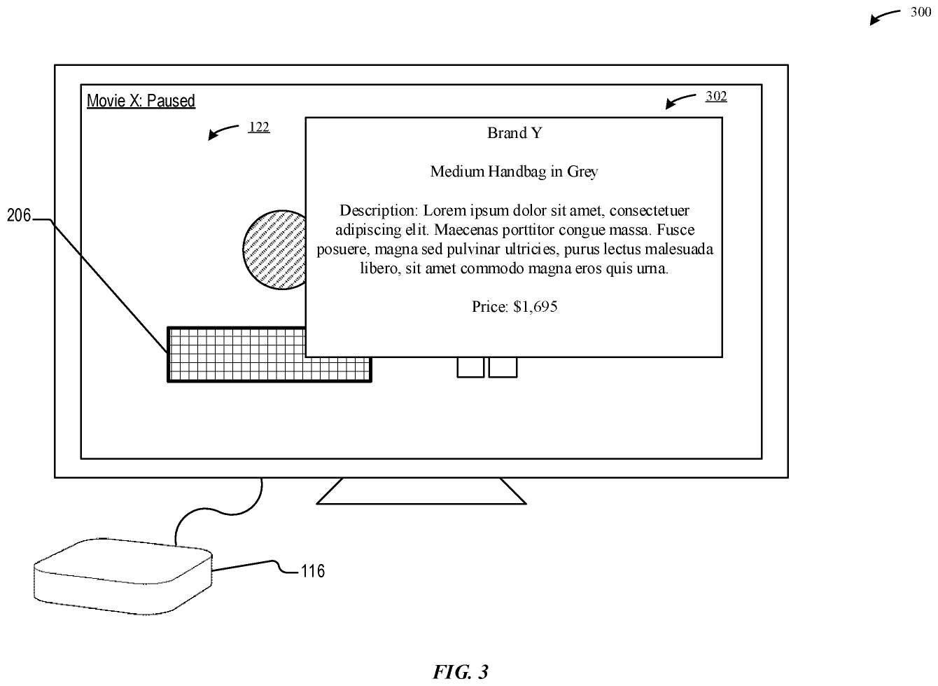

FIG. 3 illustrates a conceptual diagram 300 of an example interactive user interface 122 that provides information 301 related to a selected object 206 and options for performing a purchase event, according to some embodiments disclosed herein. The information 301 includes a brand name (e.g. “Brand Y”) of an entity that produced the object 206. In this example, the object may be a handbag. In some embodiments, the object 206 may be any suitable good or service. For example, the user may schedule a yard service, a contractor, a doctor appointment, a dentist appointment, or the like. The information 301 also includes a description of the object 206. Further, the information 301 may include a price of the selected object 206. The information 301 may be presented in an overlay screen 302 displayed on the interactive user interface 122.

In some embodiments, the content item does not need to be paused to order an object identified in the content item. For example, the content item may be streaming, and objects may be augmented such that they are identified in the interactive user interface 122. In some embodiments, a separate portion of the interactive user interface 122 may be utilized to display a list of objects included in each image frame of a content item that is streaming. The user may select one or more of the objects from the interactive user interface 122 to perform a purchase event (e.g., add to a virtual shopping cart or order directly). The playback of the content item may also be modified (e.g., slowed) to provide the user additional time to make their selection of available objects.

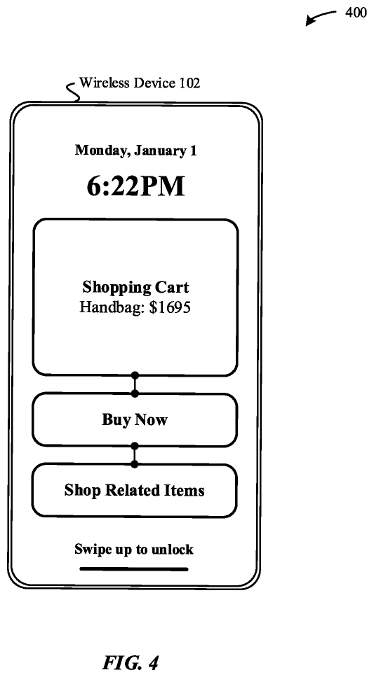

FIG. 4 illustrates an example user interface 400 of an application that enables ordering selected objects, according to some embodiments disclosed herein. The user interface is displayed on the wireless device 102. The user interface is provided via the application 118 that is executing on the wireless device 102. As depicted, the user interface presents a graphical element representing a virtual shopping cart that includes the selected handbag for $1,695. The user may select the virtual shopping cart to proceed to order the handbag and the handbag may be shipped from the entity, a third-party distributor, and so on. Another graphical user element may represent an option to buy the selected object immediately. This graphical user element reduces the number of clicks or inputs needed to order a selected object. Further, another graphical user element may enable the user to continue shopping for other objects in the content item, in another content item, on the internet, or the like.

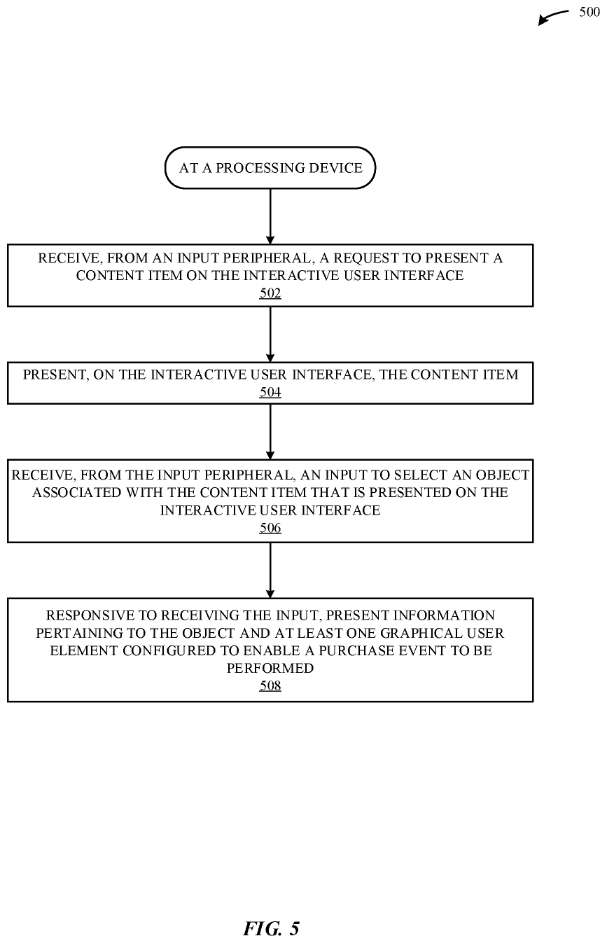

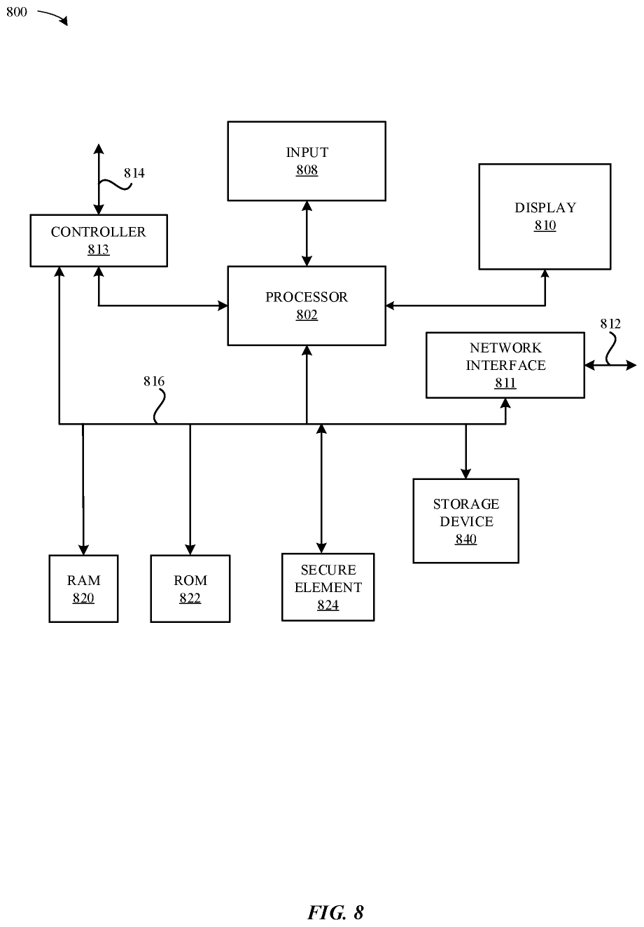

FIG. 5 illustrates a method 500 for providing an interactive user interface that enables dynamic on-demand ordering, according to some embodiments disclosed herein. The method 500 may be performed by processing logic that may include hardware (circuitry, dedicated logic, etc.), software, or a combination of both. The method 500 and/or each of their individual functions, subroutines, or operations may be performed by one or more processors of a computing device (e.g., any component (server 128, training engine 130, machine learning models 132, etc.) of computing system 116, digital media device 106, wireless device 102 of FIG. 1, and/or computing device 800 of FIG. 8) implementing the method 500. The method 500 may be implemented as computer instructions stored on a memory device and executable by the one or more processors. In certain implementations, the method 500 may be performed by a single processing thread. Alternatively, the method 500 may be performed by two or more processing threads, each thread implementing one or more individual functions, routines, subroutines, or operations of the methods.

At step 502, the processing device may receive, from an input peripheral, a request to present a content item on the interactive user interface 122. The input peripheral may include a microphone, a touchscreen, a mouse, a remote controller, a keyboard, or some combination thereof. The input peripheral may be included in the wireless device 102, the digital media device 106, and/or the computing system 116. Again, one or more machine learning models 132 may be trained using training data to perform image recognition on the content item to mark the one or more objects, such that they can be identified on the interactive user interface 122. In some embodiments, based on the input received, an appearance of the object may be modified by highlighting, shading, coloring, outlining, augmenting, or some combination thereof. For example, the object that is selected by the user using the input peripheral is shaded. In some embodiments, the input to select the object may be received in real-time or near real-time while the content item is playing or streaming on the interactive user interface 122.

At step 504, the processing device may present, on the interactive user interface, the content item. The content item may include one or more objects that are available for purchasing and/or adding to a virtual shopping cart. In some embodiments, while the content item is playing, the objects may be identified. For example, the one or more objects may be graphically identified via highlighting, outlining, shading, coloring, augmenting, bolding, and the like. In some embodiments, the one or more objects may be graphically identified when the playback of the content item is modified (e.g., slowed down, paused, etc.).

At step 506, the processing device may receive, from the input peripheral, an input to select an object associated with the content item that is presented on the interactive user interface 122. In some embodiments, the object may include an advertisement for a service provided by an entity, and the input to select the object may include scheduling the service. In some embodiments, the object may be a good (e.g., product) and/or service.

At step 508, responsive to receiving the input, the processing device may present information pertaining to the object and at least one graphical user element configured to enable a purchase event to be performed. In some embodiments, the information pertaining to the object may include a brand of an entity associated with the object, a description of the object, a price of the object, an image of the object, or some combination thereof. In some embodiments, as depicted in FIG. 3, the information may be presented as an overlay screen on the interactive user interface 122 presenting the content item.

In some embodiments, the object may be associated with an entity, and the entity may modify information pertaining to the object continuously, continually, or periodically. The entity may modify a description of the object, a price of the object, an image of the object, or some combination thereof. The processing device may communicate with a third-party service and/or application programming interface associated with the entity to receive updated information associated with the object. Accordingly, the most updated information pertaining to the object may be presented on the interactive user interface 122 when a user utilizes an input peripheral to select the object. In this way, the interactive user interface 122 is dynamic because the information pertaining to the object may be modified in real-time or near real-time as the entity modifies the information via their third-party service or application programming interface.

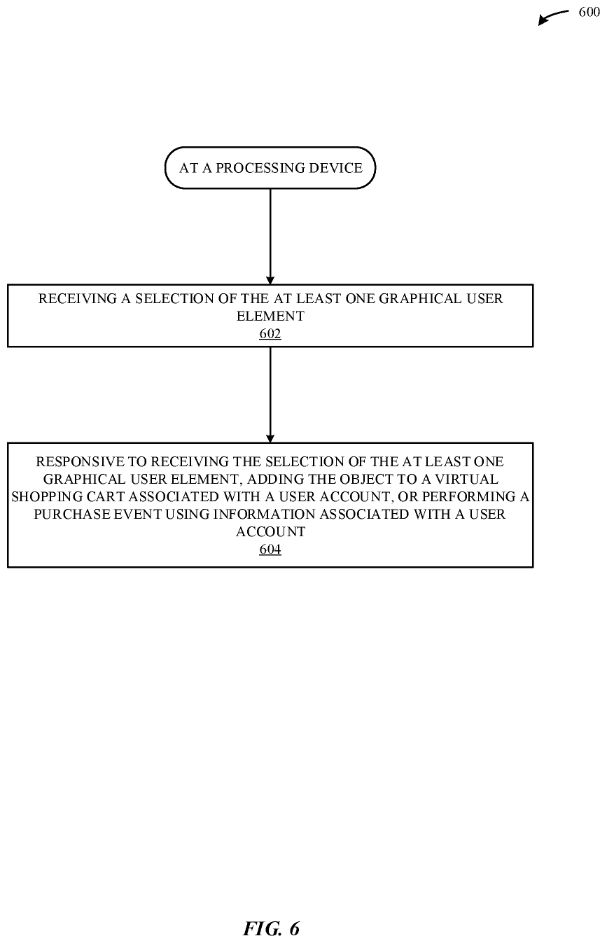

FIG. 6 illustrates a method 600 for performing a purchase event in response to receiving a selection of a graphical user element, according to some embodiments disclosed herein. The method 600 may be performed by processing logic that may include hardware (circuitry, dedicated logic, etc.), software, or a combination of both. The method 600 and/or each of their individual functions, subroutines, or operations may be performed by one or more processors of a computing device (e.g., any component (server 128, training engine 130, machine learning models 132, etc.) of computing system 116, digital media device 106, wireless device 102 of FIG. 1, and/or computing device 800 of FIG. 8) implementing the method 600. The method 600 may be implemented as computer instructions stored on a memory device and executable by the one or more processors. In certain implementations, the method 600 may be performed by a single processing thread. Alternatively, the method 600 may be performed by two or more processing threads, each thread implementing one or more individual functions, routines, subroutines, or operations of the methods.

At step 602, the processing device may receive a selection of at least one graphical user element. The selection may be received via an input peripheral. The graphical user element may be a button, a checklist, a slider, a radio button, an input box, and the like.

At step 604, responsive to receiving the selection of the at least one graphical user element, the processing device may add the object to a virtual shopping cart associated with a user account, or the processing device may perform the purchase event using information associated with a user account. The purchase event may include the processing device communicating with a third-part service or application programming interface. The interface user interface 122 may be on-demand due to the ability of the user to order an object presented in the content item in real-time or near real-time via a click of a button. In some embodiments, the purchase event may include placing an order to buy the object or adding the object to a virtual shopping cart to be ordered at a subsequent time.

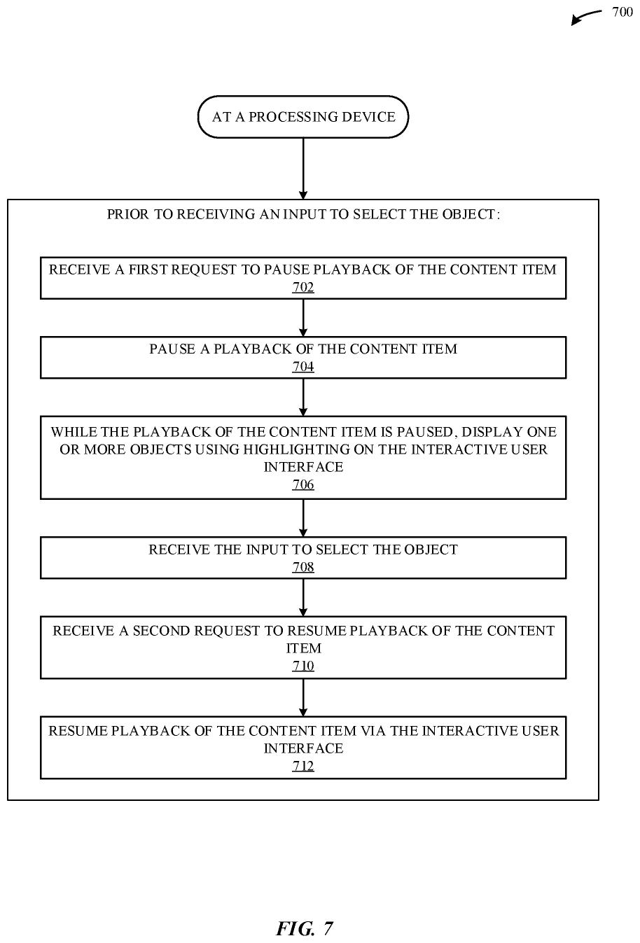

FIG. 7 illustrates a method 700 for enabling a purchase event of an object to be performed while playback of a content item is paused, according to some embodiments disclosed herein. The method 700 may be performed by processing logic that may include hardware (circuitry, dedicated logic, etc.), software, or a combination of both. The method 700 and/or each of their individual functions, subroutines, or operations may be performed by one or more processors of a computing device (e.g., any component (server 128, training engine 130, machine learning models 132, etc.) of computing system 116, digital media device 106, wireless device 102 of FIG. 1, and/or computing device 800 of FIG. 8) implementing the method 700. The method 700 may be implemented as computer instructions stored on a memory device and executable by the one or more processors. In certain implementations, the method 700 may be performed by a single processing thread. Alternatively, the method 700 may be performed by two or more processing threads, each thread implementing one or more individual functions, routines, subroutines, or operations of the methods.

Prior to receiving an input to select an object displayed in the interactive user interface, at step 702, the processing device may receive a first request to pause playback of the content item. At step 704, the processing device may pause a playback of the content item. The user may pause the content item using an input peripheral, such as a smartphone, a remote controller, a touchscreen, or the like.

At step 706, while the playback of the content item is paused, the processing device may display one or more objects using highlighting on the interactive user interface. One or more machine learning models 132 may be trained to identify the one or more objects in the content item. The one or more machine learning models 132 may be trained to flag or identify the objects with a marker or indicator. The one or more objects may be visually augments, highlighted, outlined, colored, bolded, etc. to enable the objects to be accentuated while the content item is paused. The user may use an input peripheral to select the object.

At step 708, the processing device may receive the input to select the object. The input may be received via the input peripheral. At step 710, the processing device may receive a second request to resume playback of the content item. After the object is selected, a purchase event may be performed. The purchase event may include adding the object to a virtual shopping cart or directly purchasing the object. At step 712, the processing device may resume playback of the content item via the interactive user interface 122.

FIG. 8 illustrates a detailed view of a representative computing device 800 that can be used to implement various methods described herein, according to some embodiments. In particular, the detailed view illustrates various components that can be included in a wireless device 102, a digital media device 106, a computing system 116, and the like. As shown in FIG. 8, the computing device 800 can include a processor or processing device 802 that represents a microprocessor or controller for controlling the overall operation of computing device 800. The computing device 800 can also include a user input device 808 that allows a user of the computing device 800 to interact with the computing device 800. For example, the user input device 808 can take a variety of forms, such as a button, keypad, dial, touch screen, audio input interface, visual/image capture input interface, input in the form of sensor data, etc. Still further, the computing device 800 can include a display 810 that can be controlled by the processor 802 to display information to the user. A data bus 816 can facilitate data transfer between at least a storage device 840, the processor 802, and a controller 813. The controller 813 can be used to interface with and control different equipment through an equipment control bus 814. The computing device 800 can also include a network/bus interface 811 that communicatively couples to a data link 812. In the case of a wireless connection, the network/bus interface 811 can include a wireless transceiver.

The computing device 800 also includes a storage device 840, which can comprise a single disk or a plurality of disks (e.g., hard drives), and includes a storage management module that manages one or more partitions within the storage device 840. In some embodiments, storage device 840 can include flash memory, semiconductor (solid state) memory or the like. The computing device 800 can also include a Random Access Memory (RAM) 820 and a Read-Only Memory (ROM) 822. The ROM 822 can store programs, utilities, or processes to be executed in a non-volatile manner. The RAM 820 can provide volatile data storage, and stores instructions related to the operation of the computing device 800. The computing device 800 can further include a secure element (SE) 824 for cellular wireless system access by the computing device 800.

The various aspects, embodiments, implementations or features of the described embodiments can be used separately or in any combination. Various aspects of the described embodiments can be implemented by software, hardware or a combination of hardware and software. The described embodiments can also be embodied as computer readable code on a non-transitory computer readable medium. The non-transitory computer readable medium is any data storage device that can store data which can thereafter be read by a computer system. Examples of the non-transitory computer readable medium include read-only memory, random-access memory, CD-ROMs, HDDs, DVDs, magnetic tape, and optical data storage devices. The non-transitory computer readable medium can also be distributed over network-coupled computer systems so that the computer readable code is stored and executed in a distributed fashion.

Regarding the present disclosure, it is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

The foregoing description, for purposes of explanation, used specific nomenclature to provide a thorough understanding of the described embodiments. However, it will be apparent to one skilled in the art that the specific details are not required in order to practice the described embodiments. Thus, the foregoing descriptions of specific embodiments are presented for purposes of illustration and description. They are not intended to be exhaustive or to limit the described embodiments to the precise forms disclosed. It will be apparent to one of ordinary skill in the art that many modifications and variations are possible in view of the above teachings.

What is claimed is:

1. A method for providing an interactive user interface, the method comprising, at a computing device:
receiving, from an input peripheral, a request to present a content item on the interactive user interface;
presenting, on the interactive user interface, the content item;
receiving, from the input peripheral, an input to select an object associated with the content item that is presented on the interactive user interface; and
responsive to receiving the input, presenting information pertaining to the object and at least one graphical user element configured to enable a purchase event to be performed.

2. The method of claim 1, further comprising:
receiving a selection of the at least one graphical user element; and
responsive to receiving the selection of the at least one graphical user element, adding the object to a virtual shopping cart associated with a user account.

3. The method of claim 1, further comprising:
receiving a selection of the at least one graphical user element; and
responsive to receiving the selection of the at least one graphical user element, performing the purchase event using information associated with a user account, wherein the purchase event comprises the computing device communicating with a third-party service or application programming interface.

4. The method of claim 1, wherein, based on the input, an appearance of the object is modified by highlighting, shading, coloring, outlining, augmenting, or some combination thereof.

5. The method of claim 1, wherein:
the information pertaining to the object comprises a brand of an entity associated with the object, a description of the object, a price of the object, an image of the object, or some combination thereof, and
the object comprises a good or a service.

6. The method of claim 1, further comprising presenting the information in an overlay screen on the interactive user interface comprising the content item.

7. The method of claim 1, wherein the input to select the object is received in real-time or near real-time while the content item is playing or streaming on the interactive user interface.

8. The method of claim 1, further comprising, prior to receiving the input to select the object:
receiving a first request to pause playback of the content item;
pausing a playback of the content item;
while the playback of the content item is paused, displaying one or more objects using highlighting on the interactive user interface, wherein the object is included in the one or more objects;
receiving the input to select the object;
receiving a second request to resume playback of the content item; and
resuming playback of the content item via the interactive user interface.

9. The method of claim 1, wherein the input peripheral comprises a microphone, a touchscreen, a mouse, a remote controller, a keyboard, or some combination thereof.

10. The method of claim 1, wherein the object comprises an advertisement for a service provided by an entity, and the input to select the object comprises scheduling the service.

11. The method of claim 1, further comprising using one or more machine learning models trained to perform image recognition on the content item to mark one or more objects.

12. The method of claim 1, further comprising receiving updated information associated with the object from one or more third-party services or application programming interfaces, wherein the updated information comprises an updated price for the object, an updated image for the object, an updated description for the object, or some combination thereof.

13. A non-transitory computer-readable medium storing instructions that, when executed by a processor included in a computing device, cause the computing device to carry out steps that include:
receiving, from an input peripheral, a request to present a content item on an interactive user interface;
presenting, on the interactive user interface, the content item;
receiving, from the input peripheral, an input to select an object associated with the content item that is presented on the interactive user interface; and
responsive to receiving the input, presenting information pertaining to the object and at least one graphical user element configured to enable a purchase event to be performed.

14. The non-transitory computer-readable medium of claim 13, wherein the steps further include:
receiving a selection of the at least one graphical user element; and
responsive to receiving the selection of the at least one graphical user element, adding the object to a virtual shopping cart associated with a user account.

15. The non-transitory computer-readable medium of claim 13, wherein the steps further include:
receiving a selection of the at least one graphical user element; and
responsive to receiving the selection of the at least one graphical user element, performing the purchase event using information associated with a user account, wherein the purchase event comprises the computing device communicating with a third-party service or application programming interface.

16. The non-transitory computer-readable medium of claim 13, wherein, based on the input, an appearance of the object is modified by highlighting, shading, coloring, outlining, augmenting, or some combination thereof.

17. The non-transitory computer-readable medium of claim 13, wherein:
the information pertaining to the object comprises a brand of an entity associated with the object, a description of the object, a price of the object, an image of the object, or some combination thereof, and
the object comprises a good or a service.

18. The non-transitory computer-readable medium of claim 13, wherein the steps further include:
presenting the information in an overlay screen on the interactive user interface comprising the content item.

19. The non-transitory computer-readable medium of claim 13, wherein the input to select the object is received in real-time or near real-time while the content item is playing or streaming on the interactive user interface.

20. A system, comprising:
a memory device storing instructions;
a processing device communicatively coupled to the memory device, wherein the processing device executes the instructions to:
receive, from an input peripheral, a request to present a content item on an interactive user interface;
present, on the interactive user interface, the content item;
receive, from the input peripheral, an input to select an object associated with the content item that is presented on the interactive user interface; and
responsive to receiving the input, present information pertaining to the object and at least one graphical user element configured to enable a purchase event to be performed.
